(19) United States
(12) Patent Application Publication
(10) Pub. No.: US 2018/0158239 A1
(43) Pub. Date: Jun. 7, 2018

(54) SKETCH-BASED 3D MODELING SYSTEM

(71) Applicant: Purdue Research Foundation, West Lafayette, IN (US)

(72) Inventors: Cecil Piya, West Lafayette, IN (US); Fnu Vinayak, West Lafayette, IN (US); Karthik Ramani, West Lafayette, IN (US)

(73) Assignee: Purdue Research Foundation, West Lafayette, IN (US)

(21) Appl. No.: 15/801,320

(22) Filed: Nov. 1, 2017

Related U.S. Application Data
(60) Provisional application No. 62/416,114, filed on Nov. 1, 2016.

(51) Int. Cl. G06T 17/20; G06F 3/0354; G06F 3/0488; G06T 11/20; G06T 19/20; G06F 3/0484; G06F 3/0481; G06F 3/0482; G06F 17/50

(52) U.S. Cl. CPC G06T 17/20; G06F 3/03545; G06F 3/04883; G06T 11/203; G06T 19/20; G06F 3/04845; G06F 2217/02; G06F 3/0482; G06F 17/50; G06T 2219/2012; G06T 2219/2016; G06F 2217/12; G06F 3/04817

(57) ABSTRACT

A sketch-based 3D modeling system, comprising a computer processing unit, a digital memory, and an electronic display, the computer processing unit and the digital memory configured to receive a silhouette of an object from a hand-held user input device using a touch-screen display, automatically fill in the region between the silhouette with a 3D mesh, wherein the mesh approximates a geometry of the object, and display the object on the touch-screen display.

### CROSS REFERENCE TO RELATED APPLICATIONS

The present U.S. patent application is related to and claims the priority benefit of U.S. Provisional Patent Application Ser. No. 62/416114, filed Nov. 1, 2016, the contents of which are hereby incorporated by reference in their entirety into the present disclosure.

### TECHNICAL FIELD

The present application relates to computer aided-design systems, and more specifically, to sketch-based 3D computer modeling system.

### BACKGROUND

Early-stage design is an essential part of the design process, as it allows designers to conceive and explore preliminary ideas while informing downstream processes. Its goal is not to generate full-fledged designs, but rather to aid visual observation and communication of coarse mental images. Current design practices primarily utilize sketching and 3D modeling for early-stage ideation. While sketching is an efficient means for expressing ideas, it is limited to a single viewpoint and also requires good drawing skills. Existing CAD tools on the other hand were developed in the computer as a tool paradigm, where it serves as a passive vessel for design. These methods failed to fully leverage the computer-as-a-partner approach where the digital medium is treated as an active participant in a creative design process. As a result, traditional CAD tools primarily serve final-stage detailed design processes, where expert-level design and tool operation skills are required. They are not conducive towards quick capturing and recording of fleeting ideas and rapid exploration of the design space, both of which are necessary to ensure a high quality end product and reduce design time and cost in downstream processes. Therefore, improvements are needed in the field.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 depicts an overview of a 3D design modeling process according to one embodiment.

FIG. 2 depicts a user interface for the process of FIG. 1 according to one embodiment.

FIG. 3 depicts a modes of shape creating using the process of FIG. 1 for blobby and tubular shape creating according to one embodiment.

FIG. 4 depicts a template library for importing profile curves according to one embodiment.

FIG. 5 depicts four different profile curves for creating a blobby shape from a closed profile curve according to one embodiment.

FIG. 6 depicts generation of a tubular shape from a pair of rail curves according to one embodiment.

FIG. 7 depicts creation of new shapes in-context of an existing design according to one embodiment.

FIG. 8 depicts 3D manipulation of an object using a manipulation widget according to one embodiment.

FIG. 9 depicts shape manipulation of an object using the manipulation widget of FIG. 8 according to one embodiment.

FIG. 10 depicts an overdrawing operation to modify shapes within a given domain according to one embodiment.

FIG. 11 depicts examples of how the overdrawing operation of FIG. 10 is used to modify both profile curves of blobby shapes and rail curves of tubular shapes.

FIG. 12 depicts a hole creation process within an edit mode according to one embodiment.

FIG. 13 depicts color and texture application to a shape or a part within a design model according to one embodiment.

FIG. 14 depicts replication operations performed on an incomplete design according to one embodiment.

FIG. 15 depicts tagging shapes to relevant parts according to one embodiment.

FIG. 16 depicts a data storage folder structure according to one embodiment.

FIG. 17 depicts data storage file formats for storing shape information for blobby shapes and tubular shapes according to one embodiment.

FIG. 18 depicts a data processing system for implementing the process of FIG. 1 according to one embodiment.

The attached drawings are for purposes of illustration and are not necessarily to scale.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The present disclosure provides a set of frameworks, process and methods aimed at enabling the expression, manipulation, and exploration of 3D free-form shapes and designs enabled through sketch based modeling interactions on both desktop and mobile interfaces. In an example embodiment, the present disclosure provides sketch-based techniques for generating 3D shapes from simple sketch inputs provided by the user. Herein, a set of interactive techniques use for both creating the shapes, modifying their geometry, adding aesthetic or material properties, and manipulating them in three dimensional space is provided. In the second embodiment, an interactive mechanism for constructing shapes in context of an overall design structure is provided. The present disclosure also provides various visual means to support such in-situ shape creation, and design modeling directly in 3D space. Finally, an embodiment where the design model can be hierarchically represented as a collection of individual shapes, assembly of functional parts, or a holistic concept, embodying a full design idea within the design space is provided.

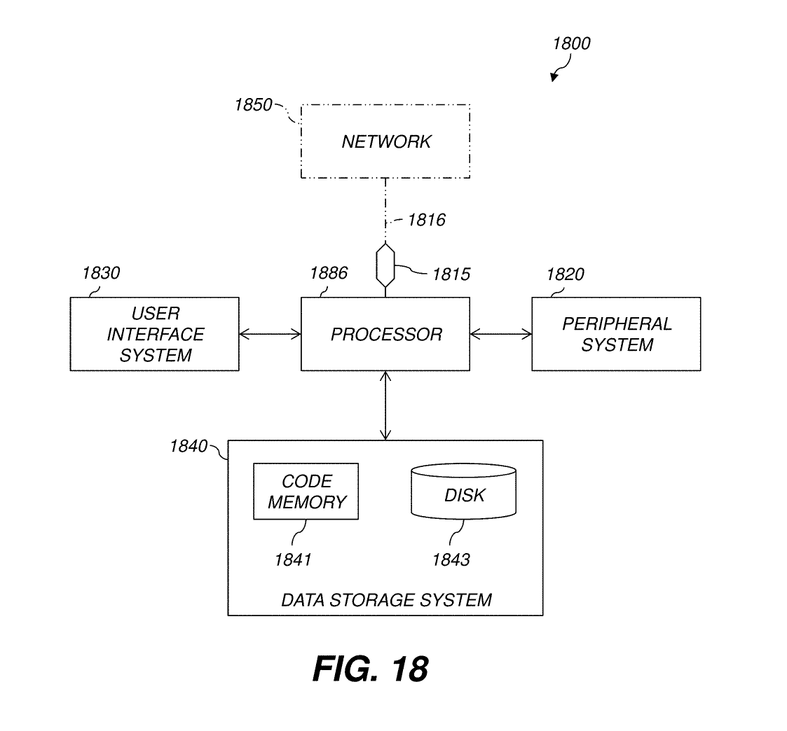

The system 1800 disclosed herein (FIG. 18) is an early-stage design ideation tool that enables both 3D content creation, particularly during the early-stage design processes where quick design ideation and rapid design space exploration are imperative. To support flexibility and intuitive modeling interactions, the system 1800 is preferably used on a digital tablet supporting both pen-based sketching and multi-touch gestures. However, it is also compatible within ordinary PCs, where a mouse and keyboard inputs are used for modeling interactions. The interface was implemented using an OpenGL based platform and was written in C++. It is compatible with a wide variety of desktop based PCs and commercial digital tablets.

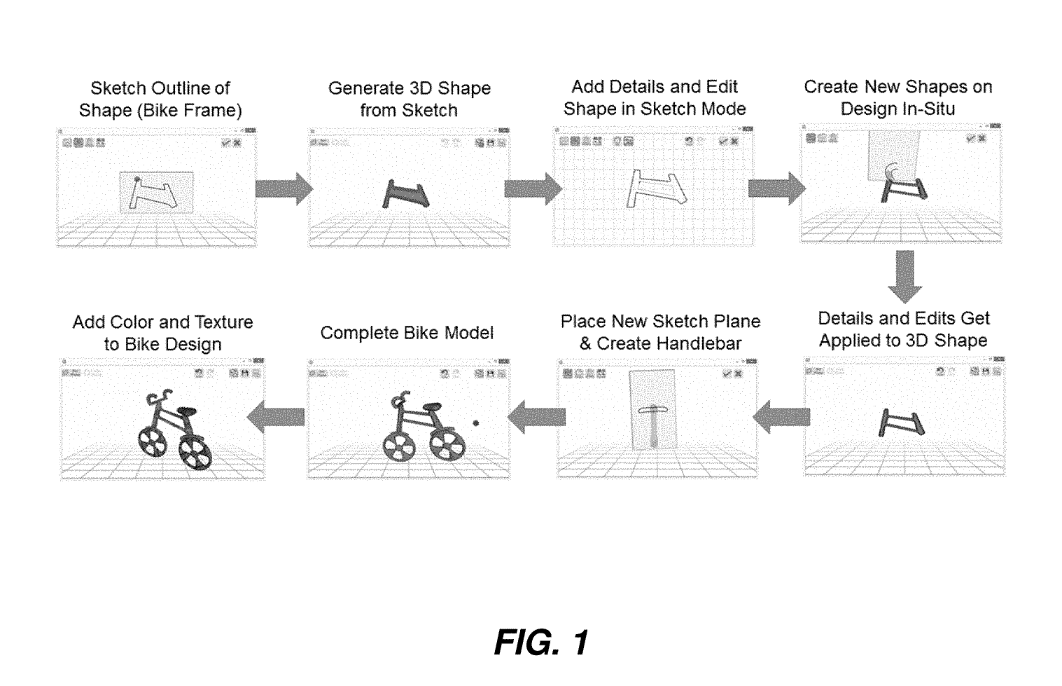

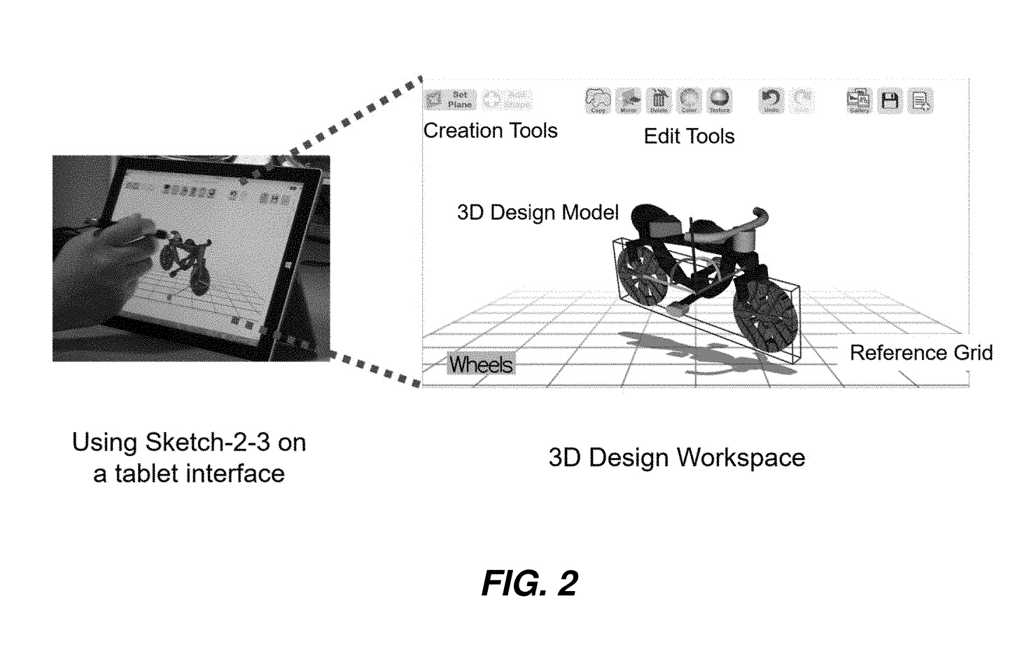

The 3D design workspace (as shown in FIG. 1 and FIG. 2) serves as and visual medium for creating new designs and interacting with design ideas and concepts. A complete design can be modeled within this workspace alone, as it prevents shifting a user's focus across different views, and also allows creation of new shapes in context of the design. There are several advantages to this workspace. First, when creating new shapes within a design, users can directly create them over their adjoining neighbors. This allows them to interactively model the shape such that it not only conforms to its environment, but also has a size and structure proportional to the rest of the design. It gives users a direct means to compare their mental idea with respect to the visually observable design, while also allowing for real-time and interactive manipulation/modification of the shape based on how the user perceives its in-context appearance.

This workspace is a highly interactive space. This space is receptive to a wide variety of 2D inputs ranging from multi-touch gestures on tablets and mobile devices, digital pen-tip contacts, mouse clicks, and keyboard commands. The system automatically recognizes direct contact inputs within the workspace, and uses ray-casting to determine what 3D element or region the user is trying to access within the space. This space is displayed using a perspective view, to aid depth perception of the 3D elements, and shadows are rendered to assist users perceive relative positioning between different elements.

To simplify user interactions and ensure quick expression of ideas, the system 1800 allows users to create 3D shapes from simple 2D sketch inputs. These inputs are directly drawn on a sketch plane using the pen or the mouse. When first starting out with blank workspace, this sketch plane first appears at a central workspace location. For subsequent shapes however, the plane can be interactively placed at a user defined location on the design. The plane can also be freely moved around using a 3D manipulation widget. Details of plane placement and manipulation will be discussed later.

Essentially, during the design modeling process, the user simply defines the cross-sectional silhouette of the shape he wants. The computer automatically fills in the region between the silhouette boundary with a 3D mesh such that the mesh approximates the geometry of the shape intended by the user. Users can define the silhouettes in two ways. First they can draw a single stroke 2D curve geometry or create a polyline curve by defining the individual vertices of the curve. Additionally, users can also create symmetric curves, by first defining a line of symmetry on the sketch plane and drawing the curve on one side of this line. The drawn curve is automatically mirrored onto the other side during the curve drawing process itself. While a freeform sketch is being drawn the sampled points are subjected to a single exponential smoothing process to ensure smoothness in the resulting curve. The raw sketch data (from both curve types) is also uniformly resampled to ensure smoothness in resulting shapes and to avoid geometric artifacts.

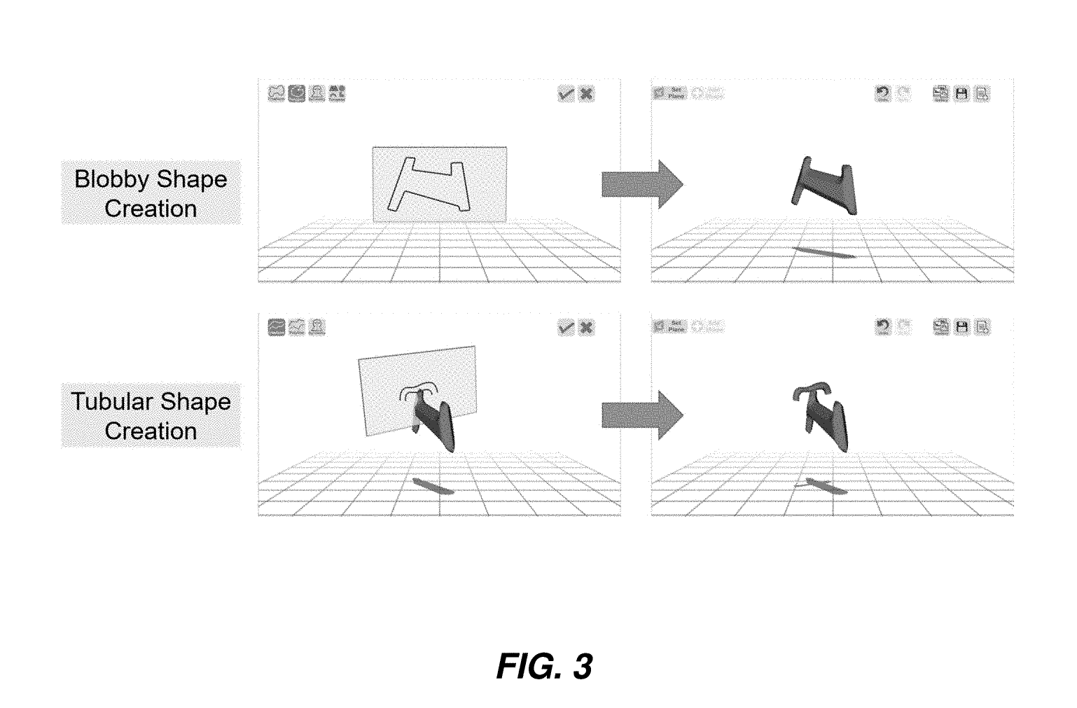

There are two types of 3D shapes that can be created using the system 1800. These are blobby shapes and tubular shapes, as shown in FIG. 3. Based on existing literature, these type shape types are capable of supporting a wide variety of 3D forms, and are particularly useful for 3D modeling purposes. They are also highly suitable for early stage design given their support for efficient shape creation and design modeling.

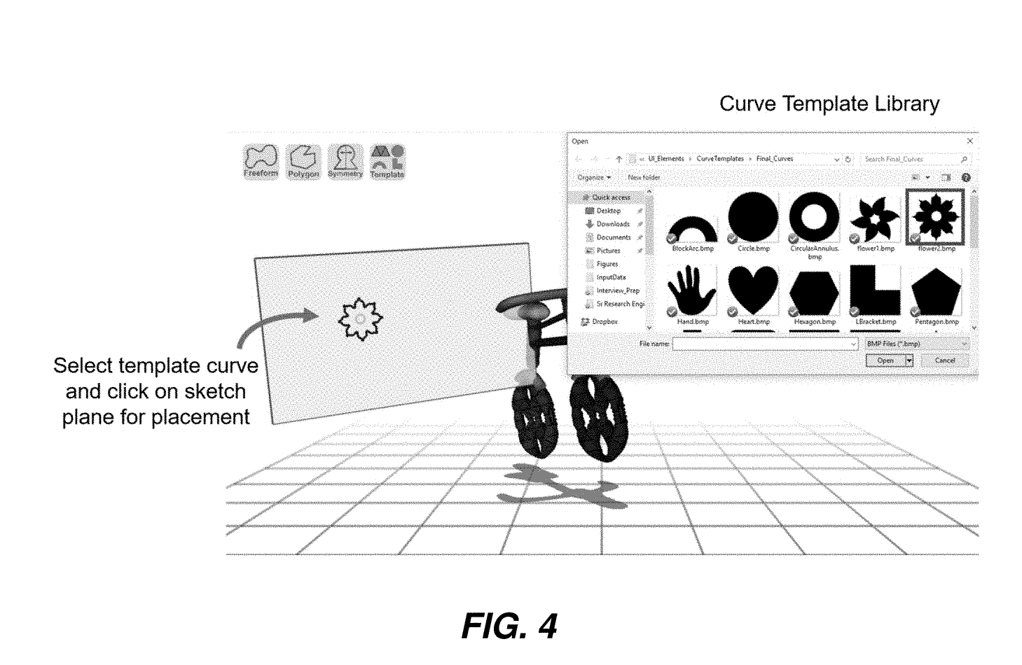

Blobby Shapes are created by first drawing a closed “profile curve” on the sketch plane (FIGS. 3 and 4). The curve can either be a single stroke free form curve or a polygon. This curve represents the medial cross sectional silhouette of the intended shape. To allow users to create precise profiles, e.g. circles, regular polygons, patterned designs etc., we provide a set of predefined template curves. For this, users can simply click on the template button in the shape creation menu, and access a wide range of templates from a dialog box. Additionally, users can choose to draw symmetric profile curves using the symmetry option.

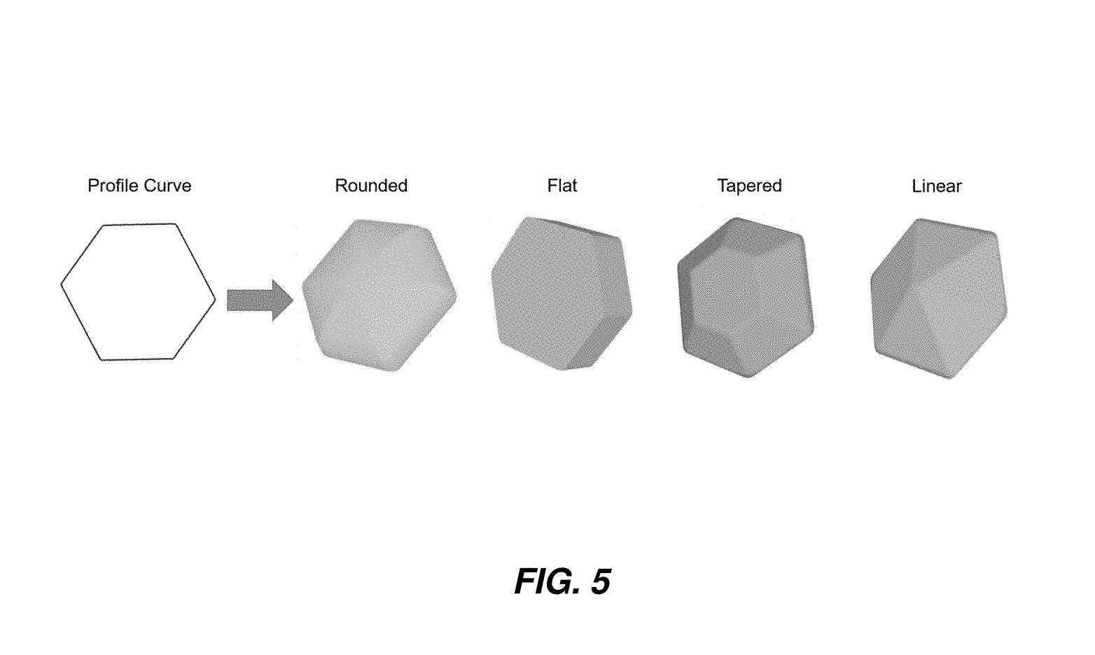

After a profile curve has been defined, the system automatically fills in the interior of the curve with a 3D mesh in order to generate the shape (FIG. 5). This process involves the following steps: (a) The inner 2D region within the profile boundary is populated with a set of interior vertices. For this a 2D grid with a predefined resolution is placed over the profile curve. The grid points lying within the profile are then used as the interior vertices. By using the grid we ensure that the interior vertices are uniformly sampled. (b) A constrained delaunay triangulation algorithm to applied on the boundary and interior vertices to generate a 2D mesh within the profile curve. (c) The interior vertices are then displaced in a direction normal to the profile curve plane. This displacement is based on a pre-defined inflation function.

The system 1800 provides users with the options to select four different kinds of inflation functions. The functions are colloquially defined as circular, tapered, linear, and flat functions. Using iconic representations, we present these functions as four different modes of blobby shape creations within the front-end user interface. However, in the back end shape computational system, these functions are mathematically represented and used for displacing the interior vertices.

Tubular shapes, sweeps, or generalized cylinders serve as highly versatile shape representations for modeling a wide variety of 3D forms. Such shapes have been shown to allow sufficient complexity and diversity within designs, and can be constructed using simple 2D sketch inputs. Tubular Shapes are defined using two open “rail curves”. Similar to profile curves, these also represent a mid-sectional silhouette of tubular shapes. They are drawn as separate curves, however the system automatically recognized when the user intends to start and terminate drawing of a given rail curve. We can use both freeform or polyline sketch inputs to draw rail curves. Moreover, the symmetry tool can be used to simultaneously draw the two rail curves as mirrored opposites of one another. This results in a symmetric tubular shape, similar to a revolved extrusion in CAD.

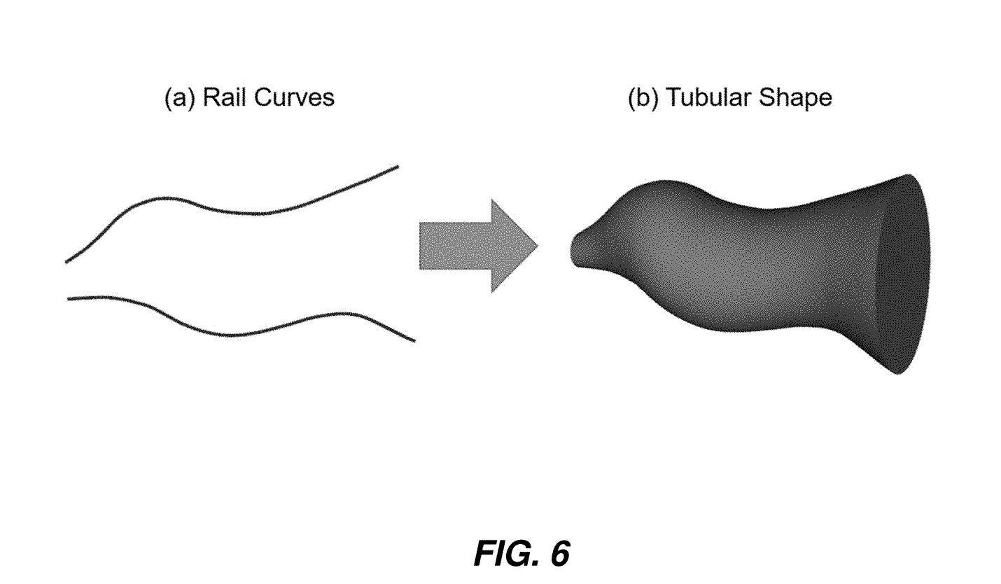

Here, a sweep geometry with a circular cross section is fitted between the two rail curves (FIG. 6). This process comprises of the following steps: (a) Each rail curve is resampled such that their points are equally spaced, and have a constant predefined number of vertices. This way a direct correspondence can be created between two vertices between the two rail curves. (b) Using this correspondence, a medial trajectory curve is then computed between the rail curves. This trajectory also has the same number of vertices as the rail curves. (c) Circular cross sections, represented by a predefined number of equally spaced vertices, are then defined between each pair of vertices between the rail curves, such that the plane of the cross section passes through a trajectory point, and the radius of the cross section is half the distance between the corresponding rail curves. (d) A 3D triangular strip is then drawn between consecutive circular cross sections. Each vertex on the cross section serves as a vertex for creating the triangular strip. The triangular strips between all cross sections collectively form the 3D tubular shape. (d) The start and end cross sections are meshed using constrained delaunay triangulation such that the tube is a closed 3D volume.

The sketch plane is a very fundamental element within the 3D design workspace, as it is used to scaffold all shape creation process. In the previous sections, we described how to create a shape on the sketch plane, but the ability to spatially define the plane within the workspace is also an essential part of system 1800, as it directly supports in context creation of shapes over a design under progress.

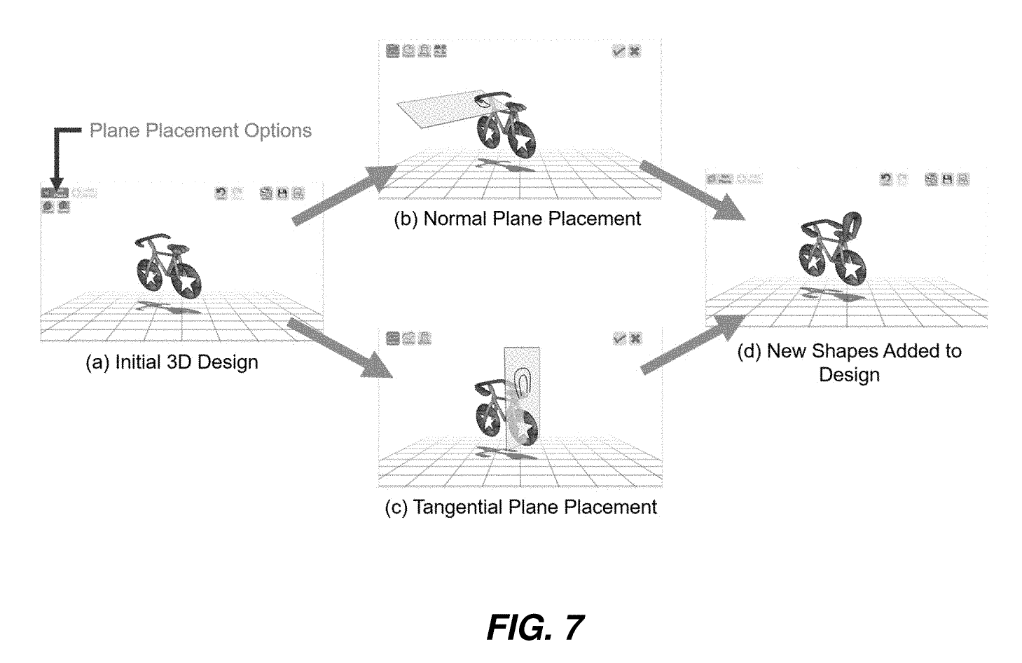

As described above, the default location of the sketch plane for the first shape is at the center of the workspace. However, for ensuing shapes, users can choose to either place the plane normal or tangential to a given shape on the under-progress design. For this, users simply need to select the placement option, and click over the desired placement location. In addition to obtaining the tangent or orthogonal direction, the back end system also automatically detects the direction of the major axis of the plane (longer edge), such that the plane orientation is consistent with the most convenient direction to draw curves (FIG. 7).

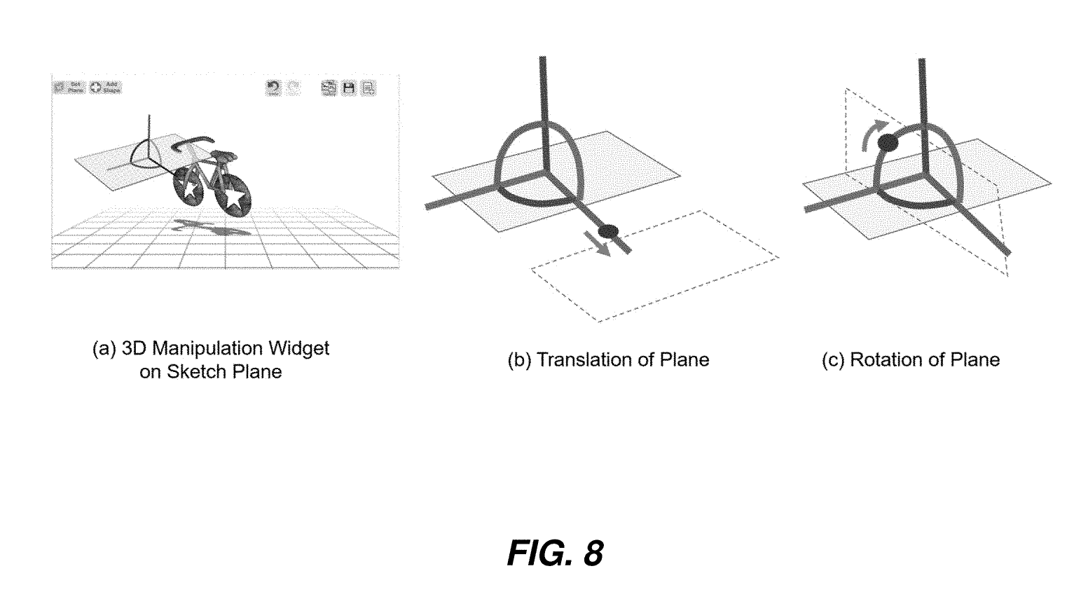

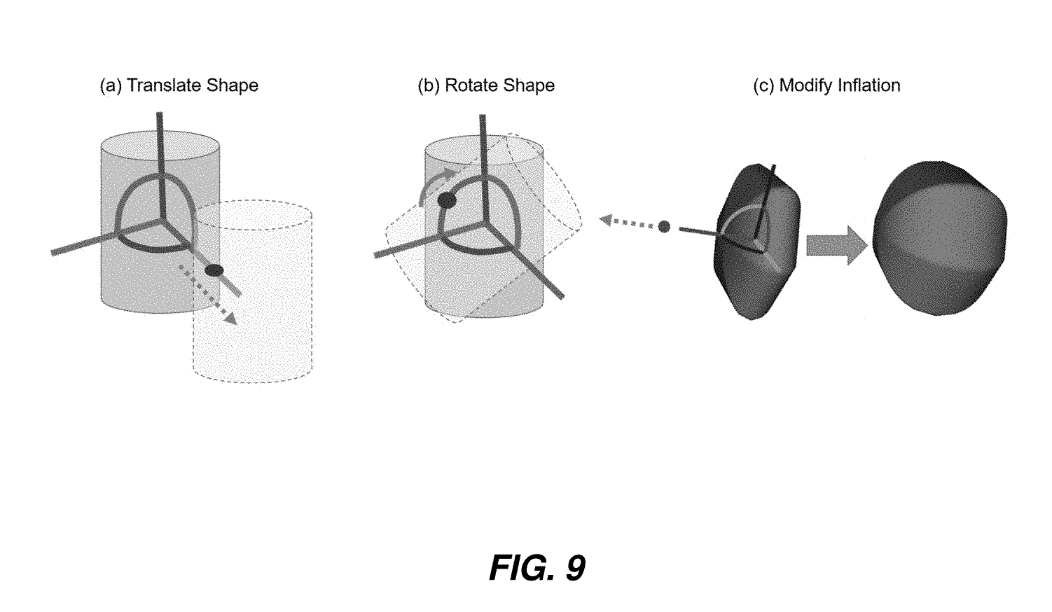

The aforementioned placement however is only an initial placement, i.e. users can further refine it using a 3D manipulation widget (FIGS. 8 and 9). Whenever a plane is initially defined in the workspace, it is automatically associated with a 3D manipulation widget, comprising of three axes and arcs between the axes. Click and dragging the axes lines causes the plane to translate in that direction, while doing the same on the arcs causes the plane to rotate along the arc. Thus, users can apply a sequence of such transformations to refine or alter the placement of the sketch plane.

The profile or rail curves for the two shapes types in system 1800 can be drawn directly on the sketch planes. It does not matter what the orientation of the plane is while drawing the curves. User can rotate the design model and/or the plane to any convenient drawing orientation. Users can also manipulate the view of the 3D workspace in the middle of the drawing process to be able to see the sketched curves from different perspectives and scales. When defining a shape in context of an under-progress design, all the curves on the sketch plane are rendered in front of all the other geometries. This way users can observe exactly how their intended shape will look like at its location within the design, and also not have to worry about occlusions when defining the shape.

Very frequently during design prototyping, the initial placement of a shape in the design need to be changed either to refine the shape's placement, test different configurations, or include another shape within the vicinity. In fact, for an early stage conceptualization process being able to quickly alter the placement of shapes leads to rapid exploration of different product forms and navigation of the design space. To support such modeling and design exploration capabilities, system 1800 allows for interactive 3D manipulation of the individual shapes in a quick and efficient manner.

Just as with the manipulation of the sketch plane, the individual shapes in the design can also be manipulated using a 3D manipulation widget (FIG. 9). When a shape is selected with a single click or tap gesture, the widget is automatically placed over the shape such that its origin is at the shape's centroid and the axes are aligned with the principle direction of the shape. Once again, dragging the axes or arcs of the widget causes that shape to transform along that direction.

In addition to spatially moving the shapes around, users can also alter the scale of the shape. This can be done by simply applying a pinch gesture on the tablet, or a SHIFT+drag gesture on the desktop interface. The back end system uses a predefined scaling factor to uniformly scale the shape. The sign of scaling (increase or decrease) is based on the motion of the dragging operation. An outward pinch or a mouse motion towards the shape indicates increased scaling, while the opposite motion indicates a decreased scaling. For blobby shapes, the inflation magnitude can also be altered. For this the widget comprises of an inflation scaling handle which can be dragged along the direction of inflation magnitude change.

At any point during the design modeling activity, the entire design model can also be rotated about its center (using an arcball rotation gesture), translated along a z-parallel plane (using a two finger drag gesture or CTRL+mouse drag on desktop), or scaled (using a two finger pinch gesture or ALT+mouse drag on desktop). These operations allow users to quickly adjust the viewing perspective and scale of the design model during new shape creation or general inspection processes.

The in context shape creation process in the 3D workspace is primarily intended to define the general outline of how a given shape should look like. In addition to that, users have the capability to further refine the shape, modify its geometry at a finer level of detail, and include features that couldn't be applied during shape creation at a global context. For this, the system 1800 interface provides a shape editing mode. The edit mode can be invoked by selecting a shape with a double tap gesture. Here, the workspace switches to a 2D sketch canvas with the shape's profile or rail curves displayed in a front facing view. By using a separate 2D view, we can provide a larger display of the profile curves, making them amenable to the operations that require finer level of control and precision than what is possible in the 3D workspace. The 2D canvas during edit mode is provided with a regular grid to assist precise placement of sketch inputs, and in the case of polyline inputs, automatic snapping to the grid points. The following operations can be performed during the edit mode.

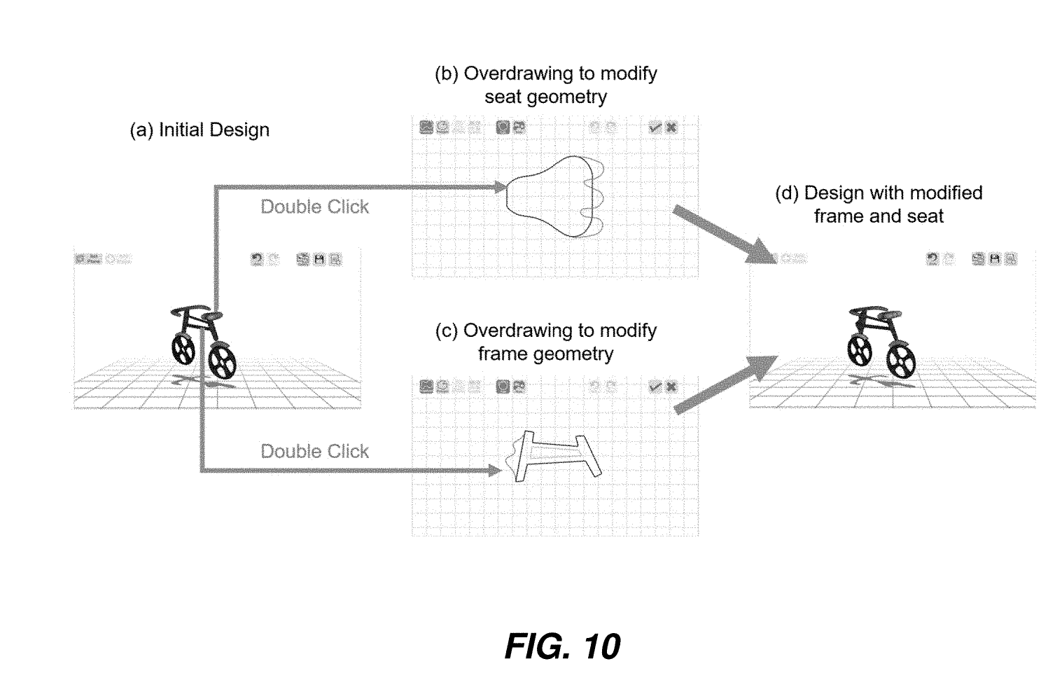

Overdrawing is a highly efficient curve editing technique that allows users to alter local regions on a curve by simply drawing over it using the system 1800 (FIG. 10). It is very similar to how we would correct or modify sketches on a paper, i.e. by drawing the improved strokes directly over the old ones. When providing an overdrawing stroke, just as with the shape creation process, users can utilize either the freeform or the polyline curve drawing option. The overdrawing technique can be used for several purposes. First, users can correct errors they might have made during the initial shape creation process. Second, they may choose to modify the geometry of the underlying curve so that the resulting shape in the design is altered based on evolving design decisions. Finally, this method also enables users to apply fine level details on the underlying curves (and resultantly on the shapes). Such details are hard to apply during initial shape creation because the scale of the shape and their underlying curves is at a smaller range within the 3D workspace. In the edit mode, the curves are magnified and displayed on a fronto-parallel view so that precise inputs are easier to apply on them.

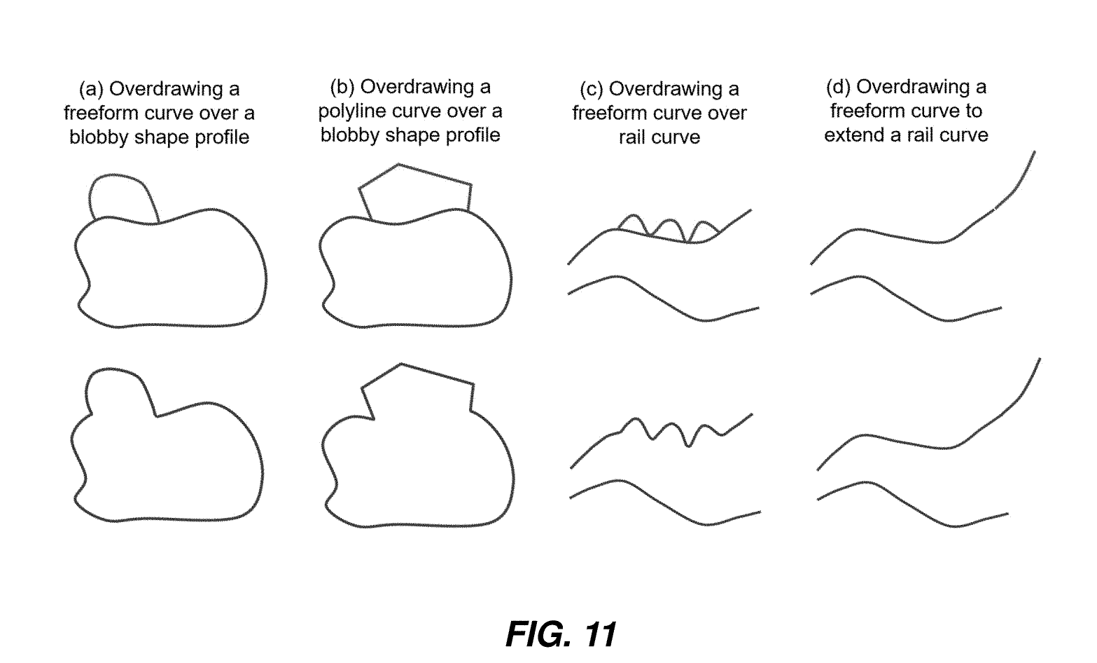

For a blobby shapes, the overdrawn curves are drawn in such a way that their starting ending points are close to the profile of the shape (FIG. 11). Upon removing the stylus tip (or releasing the mouse button), the back end system automatically determines that the stroke input was meant as a overdrawn curve. The system then applied a curve merging algorithm, resulting in the overdrawn curve to replace the portion of the profile curve it is drawn over. This technique can be used in a similar manner to edit or add details to the rail curves of tubular shapes. However, given the open-endedness of these shapes, overdrawing can also be used to either extend a rail curve or truncate it at a certain point. Overdrawing a curve entirely across an existing profile or rail curve results in the entire curve being replaced by the overdrawn curve.

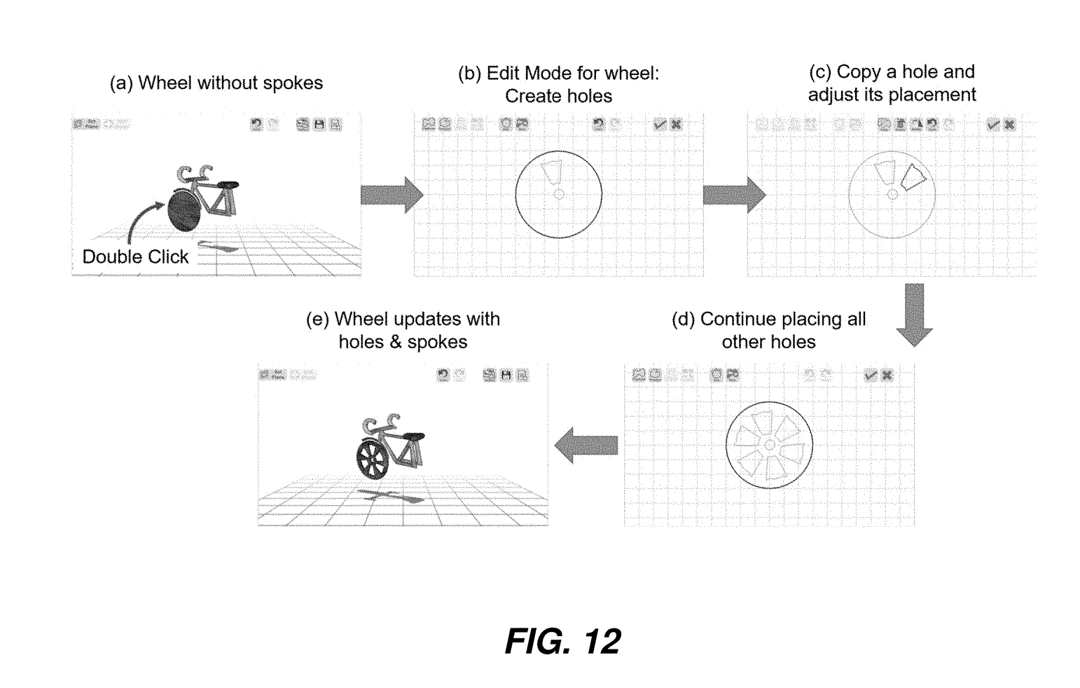

Very frequently shapes within physical products contain holes for several reasons such as weight and material reduction, aesthetic quality enhancement, and functional spacing. In the edit mode users can define as many holes as they like within a blobby shape. This can be done by simply selecting the hole option and drawing a closed freeform or polygon curve within the boundary of the profile curve we want a hole inside (FIG. 12). Upon exiting the edit mode, the 3D inflated mesh updates itself such that the hole feature within the shape is also accounted for. Here, in the remeshing process, the interior points are sampled such that they only lie between the shape profile boundary curve and the boundaries of the holes defined within the profile curve. The rest of the operations are exactly identical for constructing the resulting blobby shape.

Just as with the profile curve drawing process, the interface also allows users to borrow pre-defined template curves to serve as holes within a given blobby shape. Our system can automatically detect whether or not a hole fully resides within the profile curve, and gives an error warning to the user if this condition is not met. Additionally, the system is also cognizant of holes being too close to the profile boundary curve, in order to preclude extremely thin features (which result in geometric artifacts). The hole curves are also amenable to modification, detailing, and refinement at any point during the design modeling activity. For this, the user simply needs to go the edit mode for the relevant shape (containing the hole to be edited), and apply the overdrawing inputs in order to modify the hole shape.

While the three dimensional form of a design model provides visual information on its structure, hierarchical organization of components/shapes, and the interrelationships between different parts and shapes, color and texture provide additional dimensions of design information that can be imparted with an idea or a concept. For example, textures allow designers to communicate what type of material a given shape or part could be made of, and allude towards downstream manufacturing and production capabilities/decisions. Texture can also impart broad level information on a given part or shape's physical properties such as mass, thermal/electrical conductivity, surface smoothness and traction, malleability etc. Moreover, textures and colors can significantly enhance the aesthetic quality of a design, and provide the design model with a general finished appearance even at the early stages of the design process.

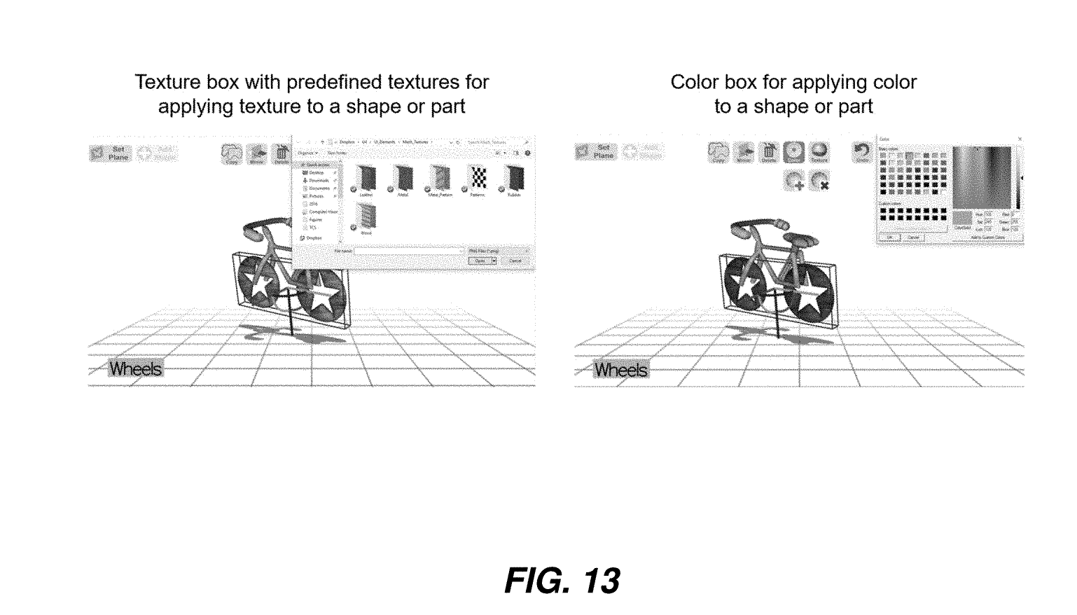

To apply the texture over a shape using the system 1800, users simply need to select it first and hit the texture button (FIG. 13). This opens up a texture dialog box, with a set of predefined textures. The textures are organized according to specific material properties. While the default Sketch-2-3 interface provides a broad range of texture categories, users can also add to this library additional textures within each category or even create new texture categories. The same process can be used for applying color over a given shape, except here a color dialog box opens up. Inside this box, users can either select from a set of predefined colors or customize a color by adjusting the RGB values. Users can also choose to apply both color and texture to a given shape. This allows users to create more variability in how they express material information on a design.

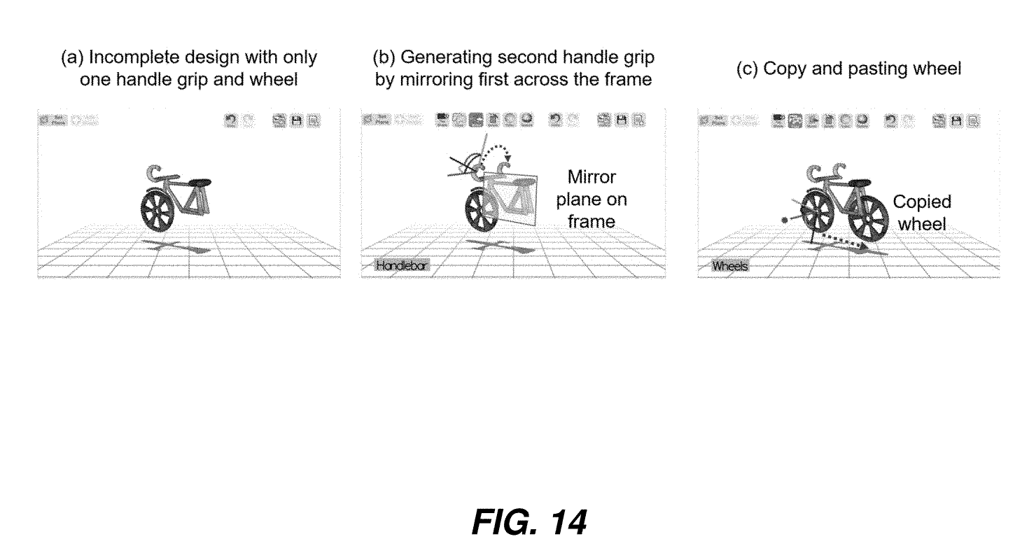

To enable users to quickly generate a pattern or symmetrical arrangement of common shapes, the system 1800 allows for copying and mirroring operations. To copy a shape users simply need to select it, hit the copy command, and define where to place it by clicking in the workspace. Mirroring operations are performed across another reference shape. Here, the shape to be mirrored is first selected, the mirror command entered, and finally the shape about which the mirror is to be performed is selected (FIG. 14). This process results in the initial shape to be copied, and the replica to be placed such that it is mirrored across the underlying plane of the second shape.

Initially when the design is constructed, it only exists as a collection of shapes, spatially arranged to achieve the form of an intended design. However the structure of a 3D design is much more complex than that. Different shapes often perform as components within a given part with a specific function in the part. Quite often, designers will want the capability to segment such parts for various design reuse and reinterpretation purposes.

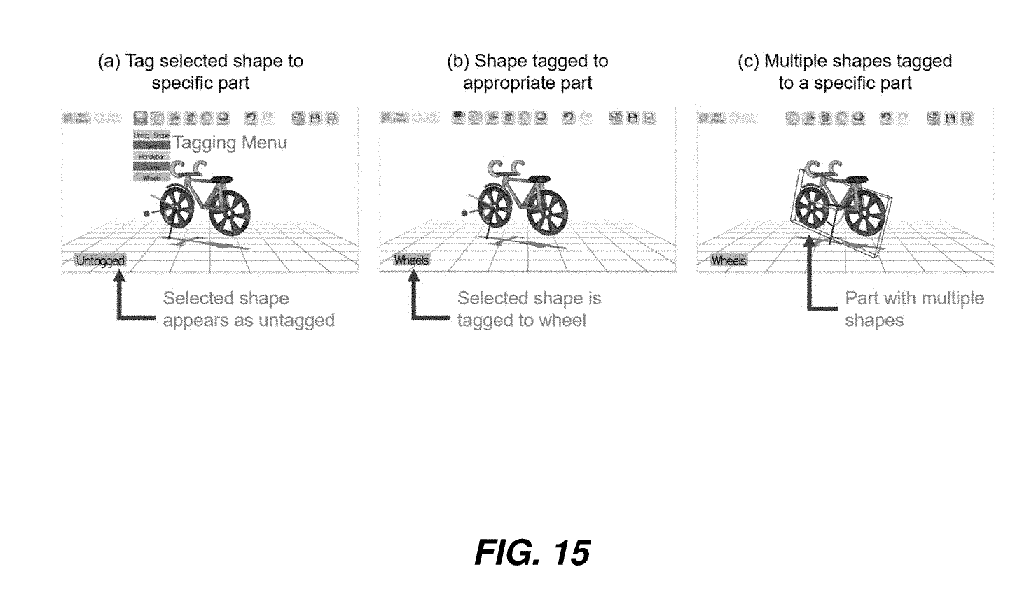

To support grouping of shapes into functional parts or meaningful clusters within the design, we provide tagging capabilities. Essentially, when working within a certain design context, users can pre-define the parts the design context will comprise of across multiple iterations or variations of design ideas. Upon constructing each variation, users can simply select a shape, and assign it to one of the pre-defined parts. We call this tagging. Just as with individual shapes, parts can also be selected within the 3D workspace. Selected parts can then be subjected to operations such as spatial manipulation with a 3D widget, color/texture additions, and replication operations. Here, all the shapes included in the part gets subjected to the operations applied to the part (FIG. 15).

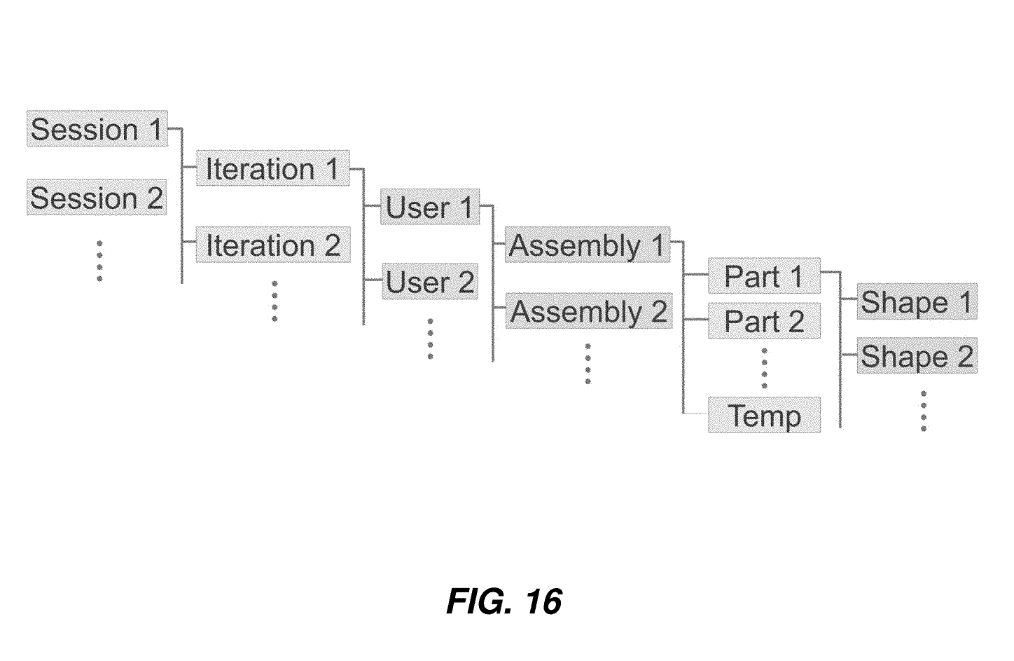

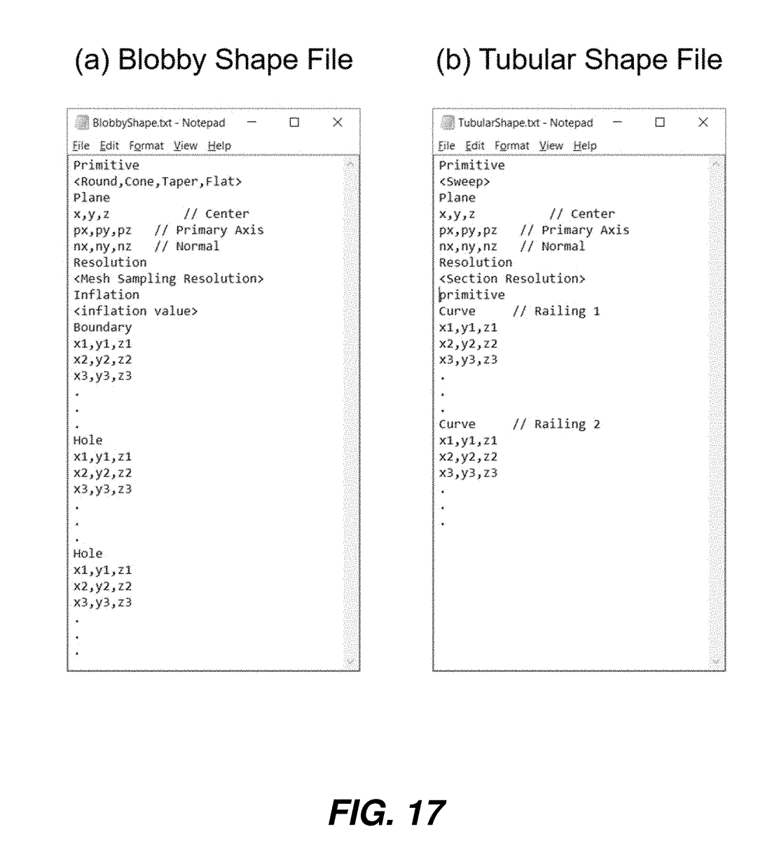

Each design model is stored in a folder with a distinct numerical IDs. Just as with the design model, this folder is also hierarchically divided into subfolders, each containing shapes from a specific part, and also includes a temporary folder for untagged shapes (FIG. 16). To store shape information, we defined a text file format containing the 3D vertices of the shapes underlying profile curves along with other appearance data (e.g. texture file location, scale, inflation magnitude etc., see FIG. 17). Whenever a design is imported or loaded, the metadata from each shape file is read by the system and corresponding shapes regenerated in the workspace.

FIG. 18 is a high-level diagram showing the components of one example of the system 1800 for analyzing data and performing other analyses described herein, and related components. The system 1800 includes a processor 1886, a peripheral system 1820, a user interface system 1830, and a data storage system 8. The peripheral system 1820, the user interface system 1830 and the data storage system 1840 are communicatively connected to the processor 1886. Processor 1886 can be communicatively connected to network 1850 (shown in phantom), e.g., the Internet or a leased line, as discussed below. It shall be understood that the system 1820 may include multiple processors 1886 and other components shown in FIG. 18. The 3D sketch and object data described herein may be obtained using network 1850 (from one or more data sources), peripheral system 1820 and/or displayed using display units (included in user interface system 130) which can each include one or more of systems 1886, 1820, 1830, 1840, and can each connect to one or more network(s) 1850. Processor 1886, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1886 can implement processes of various aspects described herein. Processor 186 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 186 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1820, user interface system 1830, and data storage system 1840 are shown separately from the data processing system 1886 but can be stored completely or partially within the data processing system 1886.

The peripheral system 1820 can include one or more devices configured to provide digital content records to the processor 1886. For example, the peripheral system 1820 can include digital still cameras, digital video cameras, cellular phones, or other data processors. The processor 1886, upon receipt of digital content records from a device in the peripheral system 1820, can store such digital content records in the data storage system 1840.

The user interface system 1830 can include a touchscreen, hand-held stylus, mouse, a keyboard, another computer (connected, e.g., via a network or a null-modem cable), or any device or combination of devices from which data is input to the processor 1886. The user interface system 1830 also can include a display device, a processor-accessible memory, or any device or combination of devices to which data is output by the processor 1886. The user interface system 1830 and the data storage system 1840 can share a processor-accessible memory.

In various aspects, processor 1886 includes or is connected to communication interface 1815 that is coupled via network link 1816 (shown in phantom) to network 1850. For example, communication interface 1815 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1815 sends and receives electrical, electromagnetic or optical signals that carry digital or analog data streams representing various types of information across network link 1816 to network 1850. Network link 1816 can be connected to network 1850 via a switch, gateway, hub, router, or other networking device.

Processor 1886 can send messages and receive data, including program code, through network 1850, network link 116 and communication interface 1815. For example, a server can store requested code for an application program (e.g., a JAVA applet) on a tangible non-volatile computer-readable storage medium to which it is connected. The server can retrieve the code from the medium and transmit it through network 1850 to communication interface 1815. The received code can be executed by processor 1886 as it is received, or stored in data storage system 1840 for later execution.

Data storage system 1840 can include or be communicatively connected with one or more processor-accessible memories configured to store information. The memories can be, e.g., within a chassis or as parts of a distributed system. The phrase “processor-accessible memory” is intended to include any data storage device to or from which processor 186 can transfer data (using appropriate components of peripheral system 1820), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1840 can be a tangible non-transitory computer-readable storage medium, i.e., a non-transitory device or article of manufacture that participates in storing instructions that can be provided to processor 186 for execution.

In an example, data storage system 1840 includes code memory 1841, e.g., a RAM, and disk 1843, e.g., a tangible computer-readable rotational storage device such as a hard drive. Computer program instructions are read into code memory 1841 from disk 1843. Processor 186 then executes one or more sequences of the computer program instructions loaded into code memory 1841, as a result performing process steps described herein. In this way, processor 1886 carries out a computer implemented process. For example, steps of methods described herein, blocks of the flowchart illustrations or block diagrams herein, and combinations of those, can be implemented by computer program instructions. Code memory 1841 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1886 (and possibly also other processors), to cause functions, acts, or operational steps of various aspects herein to be performed by the processor 1886 (or other processor). Computer program code for carrying out operations for various aspects described herein may be written in any combination of one or more programming language(s), and can be loaded from disk 1843 into code memory 1841 for execution. The program code may execute, e.g., entirely on processor 1886, partly on processor 186 and partly on a remote computer connected to network 1850, or entirely on the remote computer.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A 3D modeling system, comprising:
a) a computer processing unit;
b) a digital memory; and
c) an electronic display, the computer processing unit and the digital memory configured to:
d) receive a silhouette of an object from a hand-held user input device using a touch-screen display;
e) automatically fill in the region between the silhouette with a 3D mesh, wherein the mesh approximates a geometry of the object; and
f) display the object on the touch-screen display.

2. The system of claim 1, wherein the hand-held user input device is a stylus.

3. The system of claim 1, wherein the silhouette defines a blobby shape.

4. The system of claim 3, wherein the computer processing unit and digital memory are further configured to populate an inner 2D region within the profile boundary with a set of interior vertices, with grid points lying within the profile used as interior vertices, apply a constrained Delaunay triangulation algorithm on the boundary and interior vertices to generate a 2D mesh within the profile curve, and displace the interior vertices in a direction normal to the profile curve plane.

5. The system of claim 1, wherein the silhouette defines a tubular shape.

6. The system of claim 5, wherein the computer processing unit and digital memory are further configured to detect when the user has drawing to rail curves defining a tubular profile shape and automatically fit a sweep geometry with a circular cross section between the two rail curves.

7. The system of claim 6, wherein each rail curve is resampled such that the shape points are equally spaces and have a constant predefined number of vertices.

8. The system of claim 7, wherein a medial trajectory curve is computed between the rail curves.

9. The system of claim 8, wherein circular cross sections are defined between each pair of vertices between the rail curves, wherein the plane of the cross section passes through a trajectory point, and the radius of the cross section is half the distance between the corresponding rail curves.

10. The system of claim 9, wherein a 3D triangular strip is drawn between consecutive circular cross sections and start and end cross sections are meshed using constrained Delaunay triangulation such that the tube is displayed as a closed 3D volume.
